(19) United States
(12) Patent Application Publication
(10) Pub. No.: US 2018/0075484 A1
(43) Pub. Date: Mar. 15, 2018

(54) Method and system for advertising on a connector

(71) Applicant: Joe Zheng, Cupertino, CA (US)

(72) Inventors: Haifeng Chen, Hayward, CA (US); Joe Zheng, Cupertino, CA (US)

(21) Appl. No.: 15/352,523

(22) Filed: Nov. 15, 2016

Related U.S. Application Data
(63) Continuation of application No. 62/385,255, filed on Sep. 9, 2016.

(30) Foreign Application Priority Data
Oct. 20, 2016 (CN) 201610915020.0

(51) Int. Cl. G06Q 30/02; G06K 19/06

(52) U.S. Cl. CPC G06Q 30/0257; G06K 19/06037

(57) ABSTRACT

Techniques for utilizing an unused space on a connector are disclosed, where the connector is commonly seen in a multi-wire cable. Such a cable is a multi-wire cable including a connector coupled at an end of the multi-wire cable. The connector itself includes a substrate with at least two major surfaces, each having a first portion and a second portion. The first portion is typically used to dispose or accommodate an array of conductors. The second portion is used to include a message, wherein the message gets gazed at by a user when the user slides the connector into a socket of a device. The message becomes invisible after the connector is fully positioned or inserted in the socket.

### BACKGROUND OF THE INVENTION

### Field of the Invention

The present invention is generally related to the area of advertising on a connector, where the connector is part of a cable being portable and often used to charge or synch a mobile device.

### Description of the Related Art

A mobile device is a small computing device, typically small enough to be handheld. In general, a mobile device includes a display screen and an interface (e.g., a displayed keyboard, a microphone and a camera). Most handheld devices are also equipped with Wi-Fi, Bluetooth, near field communication (NFC) capabilities and Global Positioning System (GPS). They may allow connections to the Internet and other devices, such as an automobile or a microphone headset or can be used to provide location-based services. Also typically found on these devices are the ability to take snapshots and play digital video or audio, along with a battery power source such as a lithium battery. Increasingly mobile devices also contain sensors like accelerometers, compasses, magnetometers, or gyroscopes, allowing detection of orientation and motion. Mobile devices may provide biometric user authentication, such as using the built-in camera for face recognition or using a fingerprint sensor for fingerprint recognition.

Being portable, these mobile devices have to operate on batteries. As a result, these batteries need to be recharged from time to time. Many mobile devices are provided with a charging cable that is also referred to as a data cable since the cable itself has been expanded to provide data functions as well. For example, Apple provides what is currently called Lightning to USB Cable that allows a user to connect iPhone, iPad, or iPod to a computer's USB port for syncing and charging or a USB power adapter for convenient charging from a wall outlet. Samsung and many Android-based devices manufacturers also provide what is called MicroUSB cable for the similar purposes.

One of the common features in these charging cables is the use of a connector to be inserted into a mobile device when the mobile device is ready for syncing or charging. The connector is manually inserted into a socket of the mobile device. While inserting the connector into the socket, a user must gaze at the connector for a moment. Thus there is a need to provide certain information on the connector that enjoys the look from the user almost every day.

When the information on the connector is steady, it become decorative and draws less attention from the user over the time. Thus there is another need for making the information dynamic so that the user would present the information or connector to see how the information has been updated or modified.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to the use of an unused space of a connector commonly seen in a multi-wire cable. Such a cable is often used for charging a mobile device or data synching between two devices. According to one aspect of the present invention, a data cable is a multi-wire cable including a connector coupled at an end of the multi-wire cable. The connector itself includes a substrate with at least two major surfaces, each having a first portion and a second portion. The first portion is typically used to dispose or accommodate an array of conductors. The second portion is used to include a message, wherein the message gets gazed at by a user when the user slides the connector into a socket of a device. The message becomes invisible after the connector is fully positioned or inserted in the socket.

According to another aspect of the present invention, the message may be a plain text legible visually to a user. According to still another aspect of the present invention, the message may be a machine readable symbol illegible visually to a user. Depending on what is being encoded in the machine readable symbol, the stationary message can be made dynamic via the use of the machine readable symbol as a display linked by the content encoded in the machine readable symbol can be modified whenever there is a need.

One of the objects, features, and advantages of the present invention is to take advantage of the unused or available space on the surface of a connector for a special message, where the special message gets looked at almost every day.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a photo of Lightning to USB Cable being promoted and provided by Apple Inc. (a.k.a., Apple);

FIG. 1B shows separate blocks respectively corresponding to certain parts of an exemplary cable similar to Lightning to USB Cable;

FIG. 1C shows a set of samples that may also be embedded on a connector, where the samples include a symbol or a combination of a symbol and a logo;

FIG. 2 shows an example of disposing a message on a connector being manufactured;

FIG. 3A shows a flowchart or process of manufacturing a connector for a cable; and

FIG. 3B shows a flowchart or process of decoding a machine readable symbol imprinted on a connector.

### DETAILED DESCRIPTION OF THE PREFERRED EMBODIMENTS

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The present invention pertains to a system, a method, a platform and an application each of which is invented, uniquely designed, implemented or configured to use an available area in a connector to convey information to a user of the connector. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

One of the benefits, advantages and objectives in one embodiment of the present invention is to utilize an available area on a connector for a message disposed thereon, wherein the message is generally static but can be made dynamic via a machine-readable symbol according to one embodiment. To facilitate the description of the present invention, a message or an advertisement (ad) are interchangeably used herein. Those skilled in the art well understand that a message can be in any form (such as a text, a graph, a photo, and a machine-readable symbol) and does not have to be an advertisement.

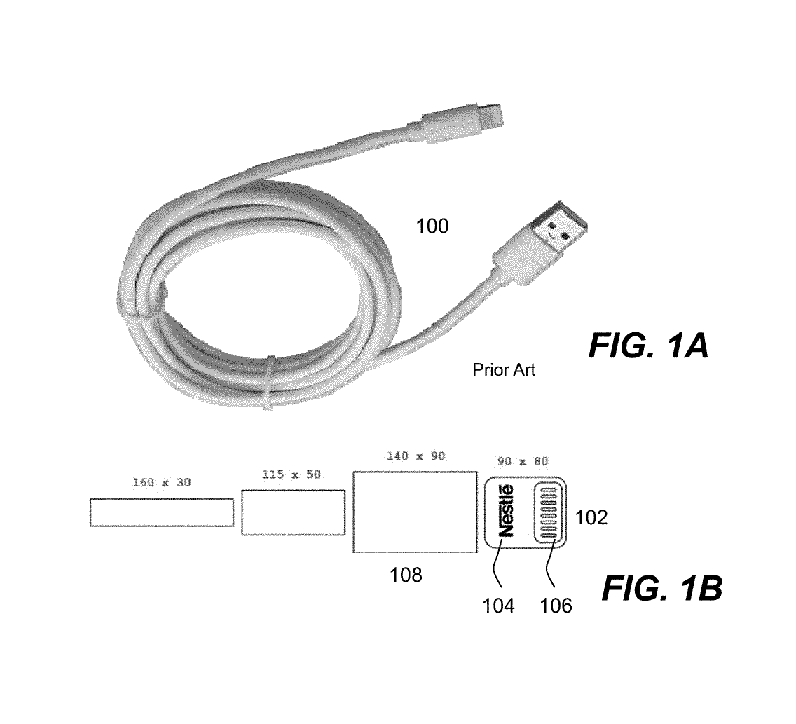

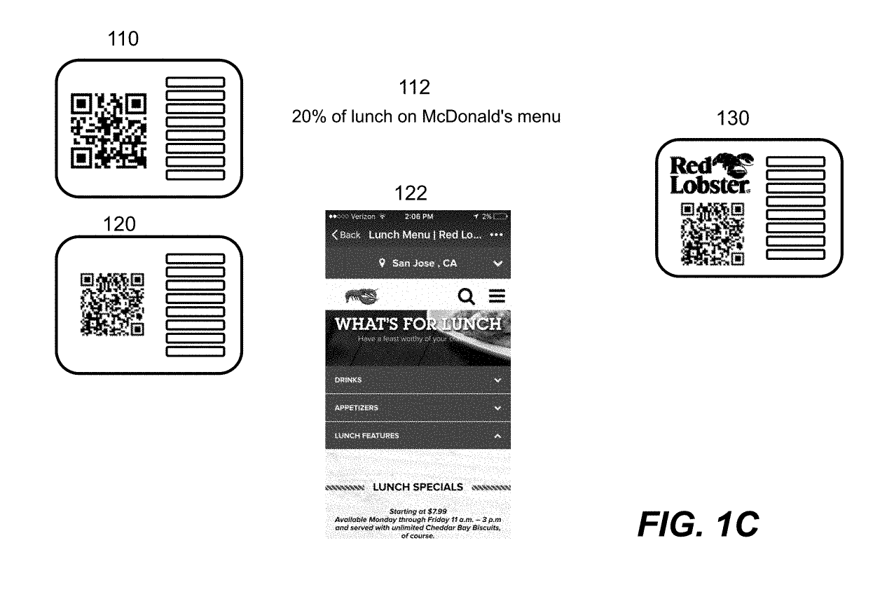

Referring now to the drawings, in which like numerals refer to like parts throughout the several views. FIG. 1A shows a photo of Lightning to USB Cable 100 promoted and provided by Apple. The cable 100 is a proprietary computer bus and power connector created by Apple Inc. Introduced on Sep. 12, 2012 to replace its predecessor, a 30-pin dock connector. The cable 100 is used to connect Apple mobile devices like iPhones, iPads and iPods to host computers, external monitors, cameras, USB battery chargers and other peripherals. Using 8 pins instead of 30 on a connector 102, on the cable, shown in FIG. 1B, the cable 100 is significantly more compact than the 30-pin dock connector and can be inserted with either side facing up.

FIG. 1B shows separate blocks respectively corresponding to certain parts of an exemplary cable similar to Lightning to USB Cable 100. It should be noted that Lightning to USB Cable from Apple is used to facilitate the description of this invention. Those skilled in the art shall appreciate that the description herein is equally applicable to other types of cable for the similar purposes (e.g., connecting a mobile device to another device). The connector 102 is the part to be inserted into a socket, where the socket is often placed pr provided somewhere around the edge of a mobile device. When a user needs to charge or data synch a mobile device, he has to gaze at the connector 102 while guiding the connector 102 into the socket.

According to one embodiment, one side of the connector 102 includes a message 104 that may be a static sign or a logo. One of the advantages, benefits and objectives in the present invention is to dispose a message that has to be viewed every time a user needs to use a charging or data cable. As shown in FIG. 1B, the message is imprinted or printed on an available space right above or next to the conductor strips 106. Once the connector 102 is inserted or accommodated fully in a socket, the message itself is no longer visible.

Another one of the benefits, advantages and objectives in one embodiment of the present invention is to conceal the message on a connector of a cable once the cable is placed in operation. In other words, the user is not obligated to gaze at the message for too long. As a result, the cable looks no different from other cables in operation. In practice, a cable contemplated in the present invention looks quite similar to other cables of the same type, the difference gets only noticed when a user uses it for connection.

As shown in FIG. 1B, the message 104 is a company logo. A logo is a graphic mark, emblem, or symbol commonly used by commercial enterprises, organizations and even individuals to aid and promote instant public recognition. FIG. 1C shows samples that may also be printed in dark ink on a connector, where the samples include a symbol or a combination of a symbol and a logo. A connector 110 is shown to have a QR code (abbreviated from Quick Response Code). A QR code is a type of barcode or two-dimensional barcode. A barcode is a machine-readable optical label that contains information about the item to which it is attached. A QR code uses four standardized encoding modes (numeric, alphanumeric, byte/binary, and kanji) to efficiently store data. Although a user would not be able to tell what is in the QR code, most of the mobile devices are equipped with a reader or loaded with an App to read out such a barcode (hence machine readable code). The illegibility of the code often causes a curious user to use a handy reader to read out the code. If the content from the code is usable, there is a high possibility that the user may very well use or redeem it when there is an opportunity. The corresponding content 112 is shown next to the code 110. If it is near lunch time, the user may bring the cable with him to a nearby McDonald to take the advantage of the discount in the code embedded or imprinted on the connector.

A connector 120 is shown to include another QR code. Once the QR code is read or decoded, a display 122 is caused to display the lunch special at Red Lobster in a city near the user. It should be noted that the location information is not needed to be coded in the symbol. In one embodiment, when the symbol is read out, a corresponding App can be designed to call on the GPS function in a mobile device to determine where the user is at the moment and look for an appropriate store corresponding to the location of the user, and subsequently display a corresponding lunch special from the store. FIG. 1C also shows a combination of a logo and a symbol.

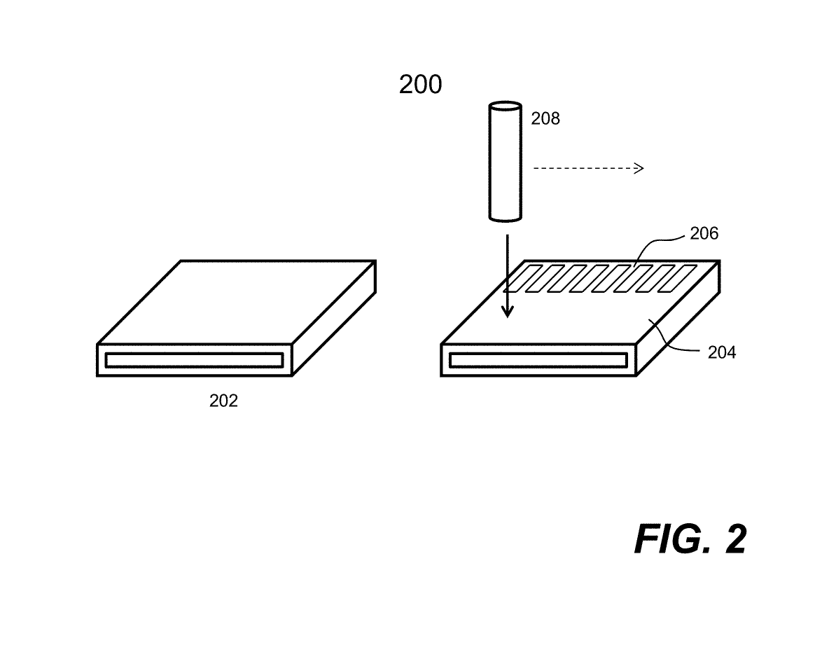

Referring now to FIG. 2, it shows an example 200 of disposing or making a message on a connector being manufactured. According to one embodiment, a flat substrate (e.g., plastic or metal) is cut into a segment on which the conductor strips may be formed. Either or both sides of the substrate may be used to have the message imprinted thereon. According to another embodiment, a metal case 202 is molded or compressed from a metal sheet depending on a process being used. Once the metal case 202 is done, a process is employed to dispose a message in an available space 204 over the conductor strips 206. Depending on the nature of the message, various methods may be used. For example, if the message is a logo, the logo may be embodied, imprinted or printed in a color in the available space 204. If the message is a barcode that is ideally presented in black and white, such a barcode is typically printed in a special ink in the available space 204. As shown in FIG. 2, a header 208 is caused to move across the space 204 to dispose a message (e.g., print a barcode in ink or embody a logo). It can be appreciated that both sides of a conductor can carry the same message or different messages.

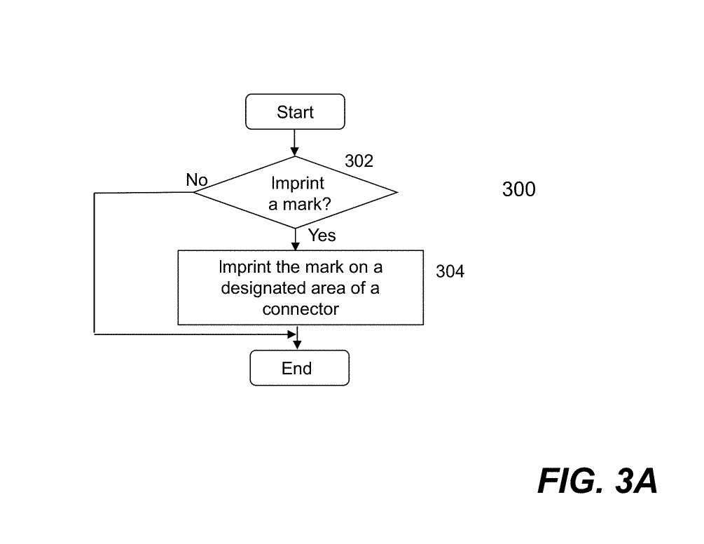

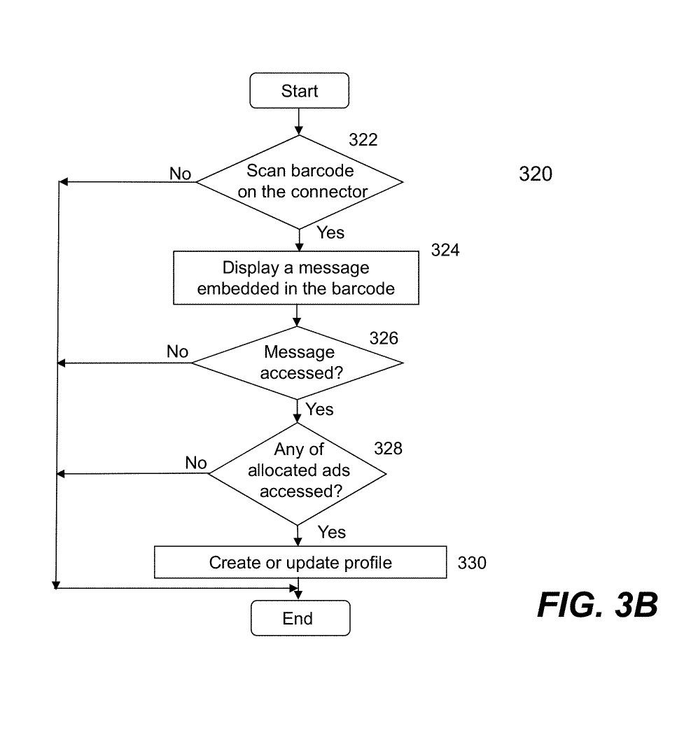

FIG. 3A shows a flowchart or process 300 of manufacturing a connector for a cable. The process 300 is started when a substrate is made out of certain material (e.g., metal or plastic). According to one embodiment, the substrate is a piece of segment or a hollow case 202 as shown in FIG. 2. At 302, the process is determined whether a message is to be disposed on an available space beyond an area used for conductors or metal strips. In one case, the manufacturer of the cables or the connectors are charged to produce OEM products for a brand manufacturer, in which case the brand manufacturer may not want to have any message on the cables or the connectors, thus the process 300 ends. In another case, the manufacturer of the cables or the connectors are in the business of selling their own branded cables and can add any messages if desired.

According to one embodiment, the manufacturer of the cables or distributors thereof may want to give away the cables with a message on the connectors, where the message is supplied or requested by an advertiser. The process 300 now goes to 302 where each of the substrates is made to carry a designated message. The cost of the cables or the connectors may be subsidized by the fees charged to the advertiser for advertising on the cables or connectors thereof. In one case, a national franchise restaurant may order one million units of such cables and distribute them free to a group of people. The message on the connectors becomes visible to these people when they use the cable for charging their mobile device or data synching with another device.

When the message is a machine readable symbol, a user understands how to decode it and may bring the cable to a place to redeem a discount offered in the symbol. As a symbol can be encoded to include a link, the content of the link at a server or another computing device may be updated and modified anytime by the advertiser, resulting in the message on a connector dynamic via the use of a machine readable symbol.

Referring now to FIG. 3B, it shows a flowchart or process 320 of decoding a machine readable symbol imprinted on a connector. The process 320 starts when a user decides to find out what is in the symbol. As an example, a connector is imprinted with a QR code in dark ink. In comparison to a QR code in black and white, only the black portions of the QR code are imprinted. The light color or metal reflection serves as the white portions of the QR code as shown in FIG. 1C.

At 322, the user uses his mobile device with a camera to image the symbol on the connector, where an App (e.g., WeChat from Tencent Technology (Shenzhen) Co Ltd. in China) decodes the symbol and extracts the content therein. The process 322 goes to 324, where the content may be displayed or a display linked by the content is displayed. According to one embodiment, a user brings a cable to a store to redeem an offer encoded in the symbol. The store may be equipped with a reader to read out the symbol and redeems the offer accordingly. At 326, depending on the nature of the content in the symbol, the user can see a simple text message or a graph in which case the process 320 ends or a display directed by the decoded link in the symbol in which case the process 320 goes to 328.

According to one embodiment, the display is a special message to the user with the cable. An advertiser controls the link in the symbol. When the symbol is decoded, the user is brought to a site to see the special message (e.g., a discount advertisement). As the site is controlled by the advertiser, the content or the advertisement at the site can be updated whenever the advertiser desires, resulting in dynamic messaging to the user via a machine readable symbol.

At 330, the user may be requested to provide some information to create a profile so that the advertiser knows how to further service the user with more focused commercial information.

It should be noted that the description of the present invention is not limited to something that can only be viewed. Those skilled in the art can appreciate that audio content may also be provided in the context of the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A data cable comprising:
a multi-wire cable;
a connector coupled at an end of the multi-wire cable, and
the connector including a substrate having a first portion and a second portion, the first portion including an array of conductors and the second portion including a message, wherein the message gets gazed at by a user when the user slides the connector into a socket, the message becomes invisible after the connector is properly positioned in the socket.

2. The data cable as recited in claim 1, wherein the substrate is a hollow case with at two surface sides, each of the two surface sides has the first portion and the second portion.

3. The data cable as recited in claim 1, wherein the message includes a plain text legible visually to the user.

4. The data cable as recited in claim 3, wherein the message is imprinted or embodied in the second portion.

5. The data cable as recited in claim 1, wherein the message includes a machine readable symbol.

6. The data cable as recited in claim 5, wherein the machine readable symbol is readable by a camera together with an application installed in a device.

7. The data cable as recited in claim 6, wherein the machine readable symbol is encoded with a text message or a link.

8. The data cable as recited in claim 7, wherein a display is shown when the link is extracted from the machine readable symbol.

9. The data cable as recited in claim 8, wherein the data cable is portable and the connector thereof is presentable to a place by the user to redeem what is encoded in the machine readable symbol.

10. The data cable as recited in claim 8, wherein the machine readable symbol is a barcode or a two-dimensional barcode.

11. The data cable as recited in claim 10, wherein only dark or black portions of the machine readable symbol are printed in permanent dark ink in the second portion.

12. The data cable as recited in claim 11, wherein a shiny surface of the substrate serves as white or reflecting portions of the machine readable symbol.

13. The data cable as recited in claim 1, wherein the message is stationary and made dynamic by updating or modifying a display directed by a link encoded in the message.

14. The data cable as recited in claim 13, wherein the message is illegible visually to the user.

15. The data cable as recited in claim 14, wherein the data cable is a message carrier by the user to show the message in the second portion to another party.

16. A method for advertising on a connector, the method comprising:
providing a connector used for a multi-wire cable, wherein the connector is coupled at an end of the multi-wire cable, the connector includes a substrate having a first portion and a second portion, the first portion including an array of conductors and the second portion including an available space; and
disposing a message in the second portion, wherein the message gets gazed at by a user when the user slides the connector into a socket, the message becomes invisible after the connector is properly positioned in the socket.

17. The method as recited in claim 16, wherein said disposing a message in the second portion comprises imprinting, embodying or printing the message in the second portion.
